(19) United States
(12) Patent Application Publication
(10) Pub. No.: US 2005/0138408 A1
(43) Pub. Date: Jun. 23, 2005

(54) Autonomic self-configuring alternate operating system environment which includes personalization

(75) Inventors: Michael Vanover, Raleigh, NC (US); Steven Welch, Gilroy, CA (US)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 10/744,562

(22) Filed: Dec. 22, 2003

(51) Int. Cl. H04L 9/00

(52) U.S. Cl. 713/200

(57) ABSTRACT

A method and system for utilizing a processing system, when a primary operating environment within the processing system is not functioning is disclosed. The method and system comprises invoking an alternate operating system environment within the processing system. The alternate operating system environment includes personalization from the primary operating system environment. Accordingly, in a system and method in accordance with the present invention, when a user experiences a malfunction while working in a primary operating system environment, an alternate operating system environment which is highly reliable and can function as a substitute for the primary operating system environment is invoked. The alternate operating system environment can offer both rescue capabilities aimed at providing emergency productivity and file access, as well as recovery for those who wish to attempt to restore the failed system back into a stable state. In the case of rescue capability, the availability of network connectivity including a browser, email and instant messaging provided by the alternate operating system environment can greatly ease the consequences of an operating system malfunction or hard drive failure.

### FIELD OF THE INVENTION

The present invention relates to processing systems and more particularly to utilizing a processing system when its primary operating system environment is malfunctioning.

### BACKGROUND OF THE INVENTION

Currently it is typical for computer users to encounter situations where the computer's operating system, such as Windows (OS & applications), does not function properly. A malfunction of the personal computing environment may be caused by a virus, a recently installed application, fragmentation of the file storage, or some unknown source. The range/effects of dysfunction may include degraded performance, blue screens, and the computer's operating system no longer booting, to the worst case of a complete hard drive failure.

For example, a person may be working away from their office on their laptop computer, when suddenly the operating system fails or malfunctions. Typically it will not be possible for the user to view files or applications on the computer, and the user must then wait until their return to office or home, and/or possibly diagnosis and repair by a technician. Although there are other modes of operation that may be available, such as “safe mode” in Windows, such modes of operation do not necessarily allow the user to access needed files or applications, and they frequently do not preserve the personalized nature of information on the user's computer (e.g., the user's specific configurations of appearance and content of applications and browser programs in use, or the user's desktop appearance and files). Many problems eventually progress to the stage where booting the computer even to safe mode is no longer possible and thus the user is typically without any assistance for resolving their immediate or longer term difficulties.

Accordingly, what is needed is a system and method for allowing the computer user to have access to files and applications on the computer after a malfunction of the operating system has made these files and applications inaccessible to the user of a personal computer.

The system and method needs to be able to allow the user easily and quickly to be able to utilize information on the computer, with content available in a format and appearance that is familiar and similar to the computer operating system environment utilized by the user before the malfunction took place. The presentation of the information must also be straight forward enough to eliminate confusion as the user begins to utilize this new alternate environment, often for the first time and often under emotional duress. The present invention addresses such a need.

### SUMMARY OF THE INVENTION

A method and system for utilizing a processing system, when a primary operating environment within the processing system is not functioning correctly is disclosed. The method and system comprises invoking an alternate operating system environment within the processing system. The alternate operating system environment includes personalization from the primary operating system environment.

Accordingly, in a system and method in accordance with the present invention, when a user experiences a malfunction while working in a primary operating system environment, an alternate operating system environment which is highly reliable and can function as a substitute for the primary operating system environment is invoked. The alternate operating system environment can offer both rescue capabilities aimed at providing emergency productivity and file access, as well as recovery for those who wish to attempt to restore the failed system back into a stable state. In the case of rescue capability, the availability of network connectivity including a browser, email and instant messaging provided by the alternate operating system environment can greatly ease the consequences of an operating system malfunction or hard drive failure.

### BRIEF DESCRIPTION OF THE DRAWINGS

FIG. 1 is a block diagram of a system in accordance with the present invention.

FIG. 2 is a flow chart which illustrates the operation of the policy block in accordance with the present invention.

### DETAILED DESCRIPTION

The present invention relates to processing systems and more particularly to utilizing a processing system when its primary operating system environment is malfunctioning. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

Utilizing a system and method in accordance with the present invention, when a user experiences a malfunction while working in a primary operating system environment, an alternate operating system environment which is highly reliable and can function as a substitute for the primary operating system environment is enabled. The alternate operating system environment can offer both rescue capabilities aimed at providing emergency productivity and file access, as well as recovery for those who wish to attempt to restore the failed system back into a stable state. In the case of rescue capability, the availability of network connectivity including a browser, email and instant messaging provided by the alternate operating system environment can greatly ease the consequences of an operating system malfunction or hard drive failure.

The usefulness of such an alternate operating system environment is primarily related to two factors:

1. Preserving and making easily available personalization information such as browser URLs, recently accessed files, and network settings in a format and appearance which is familiar to the user and similar to that provided by the primary operating system environment; and

2. The fact that users are typically either unwilling and/or unable to manage the personalization information required to enhance the user's experience (e.g., dragging and dropping to prepare for an emergency before a computer emergency takes place).

Therefore, the easy access and immediate availability of always up to date personalization information in the alternate operating system environment is highly desirable, and can significantly reduce the user's barriers to the adoption of the alternate operating system environment.

During normal operation of the computer, the continuous updating of the personalization state must be managed transparently from the user's standpoint. If updating the personalization is left up to the average user, it will not be current or available when needed during some future emergency.

Accordingly, a system and method of the present invention creates a transparent means of providing personalization from a primary operating system environment to an alternate operating system environment within a processing system assuming that the data on the operating system partition may or may not be available. To describe the features of the present invention in more detail, refer now to the following description in conjunction with the accompanying figures.

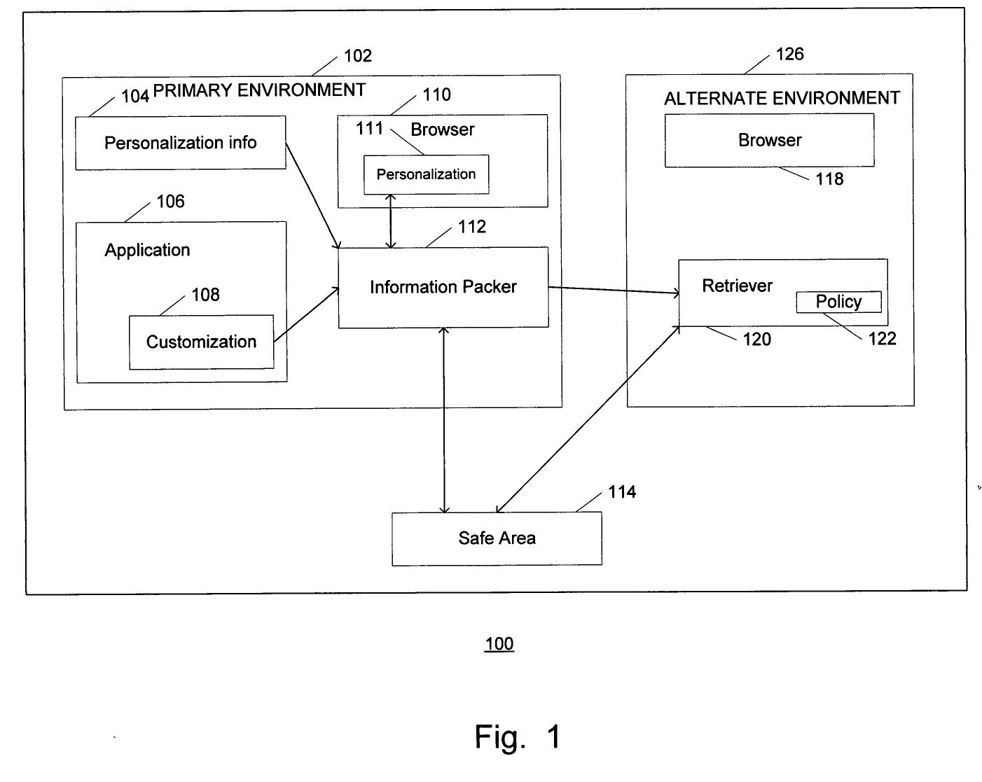

FIG. 1 is a block diagram of a system 100 in accordance with the present invention. The system 100 includes a primary operating system environment 102. The primary operating system environment 102 includes personalization information 104 for the primary operating system 102, an application 106, customization information 108 for the application 106, a browser 110 and an information packer 112. The browser also includes personalization information such as “My Favorites”, etc. The information packer 112 receives data from the personalization information customization 108 and the browser 110 and provides a mechanism for continuously updating the user information. The information packer 112 sends information therewithin periodically to a safe area 114.

The system 100 further includes an alternate operating system environment 116. Included within the alternate operating system environment 116 is a browser 118 and a retriever/unpacker 120. In this embodiment, the browser 118 includes personalization information 119. It should be readily understood that the browser personalization information 119 is just an example. Accordingly, other personalization information such as a MOST RECENT DOCUMENTS list is just as relevant. The alternate operating system environment 116 is separate from the primary operating system environment 102. It can be identical to the primary operating system environment 102. Typically, the alternate operating system environment 116 contains a subset of the primary operating system environment 102 components. The retriever/unpacker 120 obtains information related to the primary operating system environment 102 from the information packer 112 or a safe area 114 which will be described in more detail hereinbelow. The retriever/unpacker 120 further includes policy block 122.

Referring back to FIG. 1, the system 100 facilitates a transparent continuous movement of user personalization state information 104 during normal computer operation from the primary operating system environment 102 (such as Windows) the information packer 112 and the safe area 114, a location that is readable by the alternate operating system environment 116 in the event of a significant failure of the primary operating system environment 102. Personalization information 104 includes, for example, customizations (IE favorites), files (recent documents), and settings (network connection profiles). The retriever/unpacker 122 searches for customization and personalization information 104 in either the information packer 112 or the safe area 114 in accordance with policy block 122.

Policy

Policy block 122 is a set of guidelines and rules. It can be updated during the lifetime of a processing system and can differ across systems. In the preferred implementation, all policy will be managed by standard IT system management capabilities. This will be accomplished through the primary operating system environment and then indirectly applied to the alternate operating system environment. Direct management of the alternate operating system environment will typically be avoided. The policy block 122 determines how the data resources should be prioritized or combined to produce a composite personalization result. In one embodiment the policy block can be defaulted to a simple scheme and altered only if required by the appropriate IT administrator.

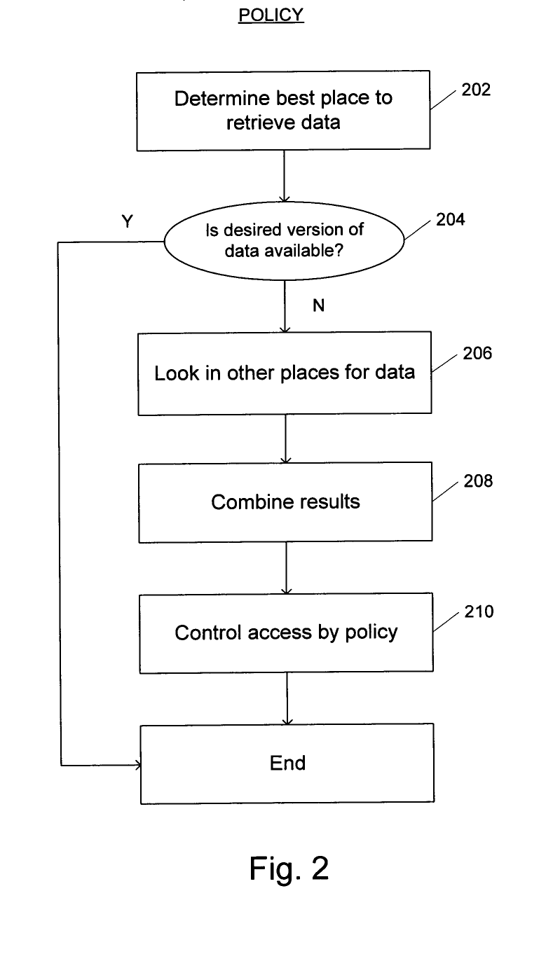

FIG. 2 is a flow chart which illustrates the operation of the policy block 122 in accordance with the present invention. First, it is determined where the best place/location is to retrieve data, via step 202. If the version of the data indicated by policy is available, for example the latest version, or the first version, or the smallest version, via step 204, then the process is completed. If this data is not available, via step 204, then other locations, such as external storage devices and network devices are searched for data, via step 206. The results are combined utilizing a predetermined policy, via step 208. Next, access is determined via the policy controls access, via step 210. There will be a simple default policy for the version of data, typically the latest version. This policy can be overwritten repeatedly as required.

Accordingly, the policy block also establishes searching priorities, typically searching in the best spot first if available (the primary OS file system), searching in other spots if required (external storage devices, network storage), combining the results according to policy, controlling access and providing a constant view to applications of a single file interface.

Since all the personalization will be derived directly from the user's primary operating system environment, in order to eliminate any additional management, the primary operating system will always be a valid source of information whenever accessible. The system and method in accordance with the present invention does not depend on access to the primary operating system environment. However, it does acknowledge by default the contents of the primary operating system environment as the most likely source of the best information if accessible.

System Restore Backups (of the RRU type) of the system image represent another viable source for this information. These may be located on a safe area, such as the local HDD, removable media or remote network media. Since backup data is intentionally exported outside the operating system partition, it is reliably accessible even if the operating system is not. Of course data on the HDD is not accessible if the drive itself fails, but information in the network or removable media is still reliable.

Finally, there can be a special form of exported information, essentially a mirrored cache of selective components of personalization such as URL favorites, recent documents and network settings. Like the backup archive, this selectively mirrored data can be exported to any combination of a safe area such as the local HDD, removable media and remote network storage. Accordingly, the alternate operating system environment could be invoked via system booting from HDD, external media (CD/DVD/USB), hibernation swapping and hypervisor swapping (hardware and software types).

At the time the alternate operating system environment is invoked, the best composite version of the personalization data is assembled according to policy rules for the combination. This policy can be defaulted to a simple combination with removal of redundancy to a hierarchical view. In this way, the user experiences the alternate operating system environment as a living extension to their primary operating system environment (typically Windows).

When the browser is invoked in the alternate operating system environment, the most recent set of favorites last viewed in Windows are automatically loaded and presented in the alternate operating system experience as well. The same is true for recent documents, access connections profile information, global dialer password, etc.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method for utilizing a processing system when a primary operating system environment within the processing system is not functioning in an acceptable manner, the method comprising:
invoking an alternate operating system environment within the processing system, wherein the alternate operating system environment receives personalization information related to primary operating system environment.

2. The method of claim 1 wherein the personalization information is received from the primary operating system environment.

3. The method of claim 1 wherein the personalization information is received from a safe area within the processing system.

4. The method of claim 3 wherein the safe area comprises any combination of a hard disk drive (HDD), external media (CD/DVD/USB), remote network storage and other removable media.

5. The method of claim 1 wherein the alternate environment can be invoked via system booting from any combination of hard disk drive, external media (CD/DVD/USB), hibernation swapping and hypervisor swapping (hardware and software types).

6. A processing system comprising:
a primary operating system environment, the primary operating system environment including personalization information; and
an alternate operating system environment, the alternate operating system environment being invoked when the primary operating system environment is not functioning in an acceptable manner, wherein the alternate operating system receives at least a portion of the personalization information.

7. The processing system of claim 6 wherein the personalization information is received from the primary operating system environment.

8. The processing system of claim 6 wherein the personalization information is received from a safe area within the processing system.

9. The processing system of claim 8 wherein the safe area comprises any combination of a hard disk drive (HDD), external media (CD/DVD/USB), remote network storage and other removable media.

10. The processing system of claim 6 wherein the alternate environment can be invoked via system booting from any combination of hard disk drive (HDD), external media (CD/DVD/USB), hibernation swapping and hypervisor swapping (hardware and software types).

11. The processing system of claim 9 wherein the primary operating system environment includes:
a browser; and
an information packer for receiving the personalization information and for receiving personalization information from the browser.

12. The processing system of claim 9 wherein the personalization information comprises personalization information of the processing system and customization information related to at least one application within the primary operating system environment.

13. The processing system of claim 12 wherein the alternate operating system includes:
a retriever/unpacker for obtaining the personalization information from the information packer when the primary operating system environment is not functioning in an acceptable manner.

14. The processing system of claim 13 wherein the information packer provides personalization information to a safe area within the processing system on a periodic basis.

15. The processing system of claim 14 wherein the retriever/unpacker obtains the personalization information from one of the information packer and the safe area based upon a policy.

16. The processing system of claim 15 which further includes a second browser for communicating with the retriever/unpacker.

17. The processing system of claim 16 wherein the safe area comprises any combination of a hard disk drive, CD, DVD, remote network storage and other removable media.

18. The processing system of claim 17 wherein the alternate environment can be invoked via system booting from any combination of hard disk drive, external media (CD/DVD/USB), hibernation swapping and hypervisor swapping (hardware and software types).

19. A computer readable medium containing program instructions for utilizing a processing system when a primary operating system environment within the processing system is not functioning in an acceptable manner, the program instructions for:
invoking an alternate operating system environment within the processing system, wherein the alternate operating system environment receives personalization information related to primary operating system environment.

20. The computer readable medium of claim 19 wherein the personalization information is received from the primary operating system environment.

21. The computer readable medium of claim 19 wherein the personalization information is received from a safe area within the processing system.

22. The computer readable medium of claim 21 wherein the safe area comprises any combination of a hard disk drive (HDD), external media (CD/DVD/USB), remote network storage and other removable media.

23. The computer readable medium of claim 19 wherein the alternate environment can be invoked via system booting from any combination of hard disk drive (HDD), external media (CD/DVD/USB), hibernation swapping and hypervisor swapping (hardware and software types).
